(19) United States
(12) Patent Application Publication
(10) Pub. No.: US 2025/0179261 A1
(43) Pub. Date: Jun. 5, 2025

(54) Purification of polymer solvolysis mixtures

(71) Applicant: RAMPF ADVANCED POLYMERS GMBH & CO. KG, Grafenberg (DE)

(72) Inventor: Michael KUGLER, Aalen (DE)

(73) Assignee: RAMPF ADVANCED POLYMERS GMBH & CO. KG, Grafenberg (DE)

(21) Appl. No.: 18/841,258

(22) PCT Filed: Feb. 23, 2023
(86) PCT No.: PCT/EP2023/054562

§ 371 Date: Aug. 23, 2024

(30) Foreign Application Priority Data
Feb. 23, 2022 (EP) 22158255.4

(51) Int. Cl. C08J 11/14; C08J 11/18

(52) U.S. Cl. CPC C08J 11/14; C08J 11/18; C08J 2367/00; C08J 2371/00; C08J 2375/04; C08J 2377/00; C08J 2467/00; C08J 2469/00; C08J 2471/00; C08J 2475/04; C08J 2477/00

(57) ABSTRACT

The present invention relates to a process for purifying a polymer solvolysis mixture to obtain a mixture of substances and its use in the production of polymers.

The present invention relates to a process for purifying a polymer solvolysis mixture to obtain a mixture of substances and its use in the production of polymers.

Polymers are ubiquitous materials and are used intensively as packaging materials, fibers, insulation materials, components of paints and adhesives, foams and construction materials, e.g. in vehicle construction or the furniture industry. Polymers are usually largely based on petrochemical starting products. Recycling processes are becoming increasingly important, especially in times of increasing scarcity of resources, but also in view of the problem of environmental pollution.

The recycling of polymers can involve the mechanical, thermal or chemical degradation of polymers. In chemical degradation, the polymers are broken down into their monomers by chemical reaction, which can be reused as starting materials in a variety of chemical processes. However, the economic significance of chemical recycling is limited by the process effort and the associated costs. In particular, complex purification processes are required to separate the polymer degradation products produced from the chemicals used, such as solvents and catalysts.

The degradation of polymer and polymer waste by means of solvolysis (such as glycolysis, alcoholysis, acidolysis, aminolysis and hydrolysis) using low-molecular cleavage reagents such as glycols, alcohols, acids, amines or water is well known. The cleavage reagents are generally used in excess in order to achieve the most quantitative conversion possible. The resulting polymer solvolysis mixtures are mixtures of different low-molecular polymer degradation products and also contain unreacted cleavage reagents used.

Polymer solvolysis mixtures are sometimes used as a mixture, including excess cleavage reagents, as a raw material. For example, polyurethane (PUR) rigid foam waste is solvolyzed using glycols. The resulting mixture of ether polyols, urethanes and free glycol is added in small quantities as a raw material in PUR rigid foam production. However, the use of these polymer solvolysis mixtures is severely limited, as the excess cleavage reagents have a negative impact on the properties of the end product during subsequent use. By-products of polymer degradation and catalysts, which generally have to be added during solvolysis to ensure sufficient polymer degradation, also are disadvantageous.

The additives, such as stabilizers, which are essential for foam stabilization in PU flexible and rigid foam production and ensure a uniform and fine-cell foam structure, also remain in the solvolysis mixture after degradation. Among other things, the stabilizers have surface-active properties and can cause considerable foaming in the solvolysis mixture, which makes processing of the solvolysis mixture considerably more difficult, if not impossible, especially under reduced pressure (<1 bar).

There is therefore a need to improve the recycling of polymers and, in particular, to provide processes in which the polymer degradation products have a lower residual cleavage reagent and by-product content.

In order to reduce the residual cleavage reagent content, the cleavage reagent was therefore partially added substoichiometrically. Although this slightly reduces the content of cleavage reagent in the polymer solvolysis mixture, the resulting mixtures have a higher viscosity or high molecular weight and are still present as a mixture with residual contents of catalyst and degradation by-products.

The polymer solvolysis mixture can also be subjected to conventional distillation in order to reduce the cleavage reagent content. However, the polymer solvolysis mixtures after distillation are still present as unfavorable mixtures of polymer degradation products and may have increased catalyst contents. Conventional separation processes also have the disadvantage that side reactions occur due to the thermal load. The high temperatures during distillation required to remove the cleavage reagents and/or by-products as completely as possible have the disadvantage that the formation of polymers with high molecular weights is promoted by side and back reactions of the polymer degradation products. The resulting agglomerates lead to phase separation in the polymer solvolysis mixture, which restricts the direct use of the polymer solvolysis mixture in the production of new polymers.

Despite the high relevance of processes for the degradation of polymers, there is currently a lack of processes that enable the separation of polymer solvolysis mixtures into sufficiently pure polymer degradation products and the recovery of cleavage reagents (solvent) under economic conditions.

Surprisingly, it was found that the polymer solvolysis mixture purified according to the process of the invention can be used directly and in high proportions—if not as the sole starting material—for the production of new polymers. The purification process of the present invention prevents the undesired back-reaction of the polymer degradation products in the polymer solvolysis mixture, but nevertheless ensures that cleavage reagents and/or by-products are removed almost quantitatively.

Since cleavage reagents are separated quantitatively by the process according to the invention, the cleavage reagents can also be used in significant excess and thus the solvolysis processes can be run without or with a greatly reduced catalyst content at low reaction times or reaction temperatures, i.e. more economically.

The separated cleavage reagent can be reused as a cleavage reagent for the next process (recycling).

The polymer solvolysis mixtures purified in this way are suitable as polymer raw materials in terms of both quality and technical properties (e.g. homogeneity, viscosity, storage stability, content of low-molecular monomers, by-products).

The use of the polymer solvolysis mixtures according to the invention for the production of polymers also reduces disposal costs. Overall, this creates a cycle that combines economic and ecological advantages.

A first aspect of the present invention relates to a method for purifying a polymer solvolysis mixture, comprising the steps of:
(a) providing the polymer solvolysis mixture;
(b) treating the polymer solvolysis mixture at a pressure <1 mbar and a temperature in the range from 90 to 170° C.; and
(c) removing at least one compound with a molar mass of ≤250 g/mol during step (b) to obtain a mixture of substances.

The polymer solvolysis mixture provided in step (a) typically comprises polymer degradation product, solvent, in particular cleavage reagent, and optionally at least one catalyst. Preferably, the polymer solvolysis mixture is liquid at room temperature (20° C.) and more preferably in the form of a solution. In one embodiment, the polymer solvolysis mixture provided in step (a) is subjected to solid/liquid filtration prior to step (a).

The term “polymer solvolysis mixture” used herein means that the provided mixture is obtained by solvolysis of polymer. Solvolysis reactions of polymers are known to the skilled person and comprise, for example, glycolysis, alcoholysis, acidolysis, aminolysis or hydrolysis of polymer. The solvolysis reaction takes place using solvolysis cleavage reagents such as glycols (in the case of glycolysis), alcohols (in the case of alcoholysis), acids (in the case of acidolysis), amines (in the case of aminolysis) or water (in the case of hydrolysis).

The polymer may be selected from the group consisting of polyurethane, polyester, polyether ester, polyamide, polycarbonate, polyisocyanurate or a mixture thereof. In a preferred embodiment, the polymer may be selected from the group consisting of polyurethane and/or polyester, in particular polyurethane, in particular polyester polyurethane and/or polyether polyurethane.

The polymer solvolysis mixture provided in step (a) preferably comprises at least one solvent, in particular a solvolysis cleavage reagent. The cleavage reagent is preferably selected from alcohols, glycols, amines, water or mixtures thereof. Suitable solvolysis cleavage reagents are known to the skilled person.

In one embodiment, in particular in aminolysis, the cleavage reagent is at least one polyamine, in particular at least one diamine, such as for example ethanediamine, propanediamine, butanediamine and/or hexanediamine, and/or a triamine, such as for example ethanetriamine, propanetriamine, butanetriamine, pentanetriamine and/or hexanetriamine, and/or hydroxylamines such as for example ethanolamine, preferably a diamine.

In a preferred embodiment, in particular in alcoholysis or glycolysis, the cleavage reagent is selected from at least one monoalkohol, in particular methanol, ethanol, propanol, butanol, pentanol and/or hexanol, at least one diol, in particular ethylene glycol, diethylene glycol, polyethylene glycol, propylene glycol, dipropylene glycol, polypropylene glycol, butanediol, pentanediol and/or hexanediol, at least one triol, in particular glycerol and/or trimethylolpropane, and at least one tetrol, in particular pentaerythrol, and at least one hydroxycarboxylic acid, in particular ricinoleic acid and lactic acid.

In a preferred embodiment, in particular in acidolysis, the cleavage reagent is selected from at least one polycarboxylic acid, in particular a dicarboxylic acid, such as succinic acid, glutaric acid, adipic acid, hexanedicarboxylic acid, heptanedicarboxylic acid, azealic acid, sebacic acid, decanedicarboxylic acid, dodecanedicarboxylic acid and/or phthalic acid, and/or at least one tricarboxylic acid, such as trimelittic acid, and/or at least one polycarboxylic acid anhydride, in particular a dicarboxylic acid anhydride, such as succinic acid anhydride, glutaric acid anhydride, adipic acid anhydride, hexanedicarboxylic acid anhydride, azealic acid anhydride and/or phthalic acid anhydride, and/or at least one tricarboxylic acid anhydride, such as trimelittic acid anhydride, particularly preferably from at least one polycarboxylic acid, more preferably at least one dicarboxylic acid.

Hydrolysis is carried out using water as a cleavage reagent.

In one embodiment, the solvent, in particular the cleavage reagent, has a molecular weight of 15-250 g/mol, preferably 30-180 g/mol.

The content of solvent or cleaving reagent in the polymer solvolysis mixture provided may, for example, be more than 40 wt. %, preferably 50-95 wt. %, for example 70-90 wt. %, in particular in the case of an alcoholysis mixture, or 40-60 wt. %, in particular in the case of a glycolysis mixture, based on the total weight of the mixture.

In a further embodiment, the solvolysis is further carried out using at least one catalyst suitable for degrading polymers, in particular a alkaline and/or organometallic catalyst.

The at least one alkaline catalyst may be selected from the group consisting of alkali metal alcoholate, in particular sodium methanolate, potassium methanolate, sodium ethanolate, potassium ethanolate, sodium propanolate, potassium propanolate, sodium butanolate and/or potassium butanolate, alkali metal hydroxide, in particular sodium hydroxide and/or potassium hydroxide, and alkali metal acetate, in particular sodium acetate and potassium acetate.

The at least one organometallic catalyst may be selected from the group consisting of zinc acetate, magnesium acetate, cobalt acetate, tin octoate, dibutyltin dilaurate, titanium tetraisopropanolate and titanium tetrabutanolate. A metal catalyst such as tetrabutyl titanate is particularly present when the solvent (i.e. the solvolysis cleavage reagent) is a glycol, such as diethylene glycol.

The content of catalyst in the polymer solvolysis mixture provided can, for example, be more than 0 and up to 10 wt. %, preferably 0.1-5 wt. %, in particular 0.5-3 wt. %, based on the total weight of the mixture.

In one embodiment, solvolysis is carried out at elevated temperature, in particular at a temperature in the range of 30-300° C., more preferably 100-250° C., more preferably 140-220° C., and optionally at elevated pressure, in particular at a pressure of 1-200 bar, preferably 5-50 bar, more preferably 10-30 bar.

In a further embodiment, solvolysis is carried out in a solvolysis reactor, which preferably comprises an agitator. The agitator can, for example, convey axially or radially and stir in one or more stages if necessary. Furthermore, the solvolysis reactor can be sealed gas-tight. In one embodiment, an oxygen-reduced or oxygen-free atmosphere may be present in the solvolysis reactor. If necessary, an inert gas atmosphere may be present in the reactor. Examples of a suitable inert gas are nitrogen and noble gases, such as argon.

The polymer solvolysis mixture preferably comprises at least one polymer degradation product, at least one cleavage reagent and optionally at least one catalyst.

The polymer degradation product obtained by solvolysis may be selected from polyamines, polyols, carbamates, polycarboxylic acids, polycarboxylic acid esters, hydroxycarboxylic acids, hydroxycarboxylic acid esters or mixtures thereof. Preferably, the polymer degradation product is selected from polyamines, polyols, carbamates, polycarboxylic acids and/or polycarboxylic acid esters. In a preferred embodiment, the polymer degradation product comprises at least one polyol and at least one polyamine.

The polymer degradation product can have a weight average molecular weight of 50-50,000 g/mol, preferably 80-10,000 g/mol.

The content of polymer degradation product in the polymer solvolysis mixture provided can, for example, be up to 70 wt. %, preferably 5-60 wt. %, such as 5-20 wt. %, in particular in the case of a glycolysis mixture, or 40-60 wt. %, in particular in the case of an alcoholysis mixture, based on the total weight of the mixture.

In one embodiment, the polymer degradation product comprises at least one polyol, in particular when the solvolyzed polymer is a polyurethane and/or polyester. The term “polyol” refers to compounds with at least 2, i.e. 2, 3, 4 or more, hydroxyl groups. A polyol within the meaning of the invention is preferably a polyether polyol, in particular aliphatic polyether polyol, e.g. polyethylene glycol or polypropylene glycol, or aromatic polyether polyol, polyester polyol, in particular aliphatic polyester polyol or aromatic polyester polyol, diethylene glycol, dipropylene glycol, C1-6-alkylene glycol, in particular hexanediol, butanediol, ethylene glycol and neopentyl glycol, C1-8-alkylene polyol, in particular trimethylolpropane and glycerol, or a mixture thereof.

In one embodiment, the polymer degradation product comprises at least one polycarboxylic acid, in particular if the solvolyzed polymer is a polyester. A polycarboxylic acid within the meaning of the invention may comprise, for example, an aromatic polycarboxylic acid, preferably phthalic acid or terephthalic acid, or an aliphatic polycarboxylic acid, preferably C1-12 alkylenedicarboxylic acid, more preferably C1-6 alkylenedicarboxylic acid, for example adipic acid, succinic acid or glutaric acid, esters or mixtures thereof.

In one embodiment, the polymer degradation product comprises at least one hydroxy-functionalized carboxylic acid, in particular when the solvolysed polymer is a polyester. A hydroxy-functionalized carboxylic acid within the meaning of the invention may comprise, for example, a hydroxyhexamethylenecarboxylic acid, a hydroxypopanoic acid such as lactic acid, a hydroxy fatty acid or hydroxybutyric acid.

In one embodiment, the polymer degradation product comprises at least one polyamine, in particular when the solvolyzed polymer is a polyamide and/or a polyurethane. The term “polyamine” refers to compounds having at least 2, that is 2, 3, 4 or more, preferably 2 or 3, amino groups. A polyamine within the meaning of the invention can be, for example, an aromatic diamine, preferably 2,4-diaminotoluene, 2,6-diaminotoluene, 4,4′-diaminodiphenylmethane, 2,2′-diaminodiphenylmethane, 2,4′-diaminodiphenylmethane or aniline, an aliphatic polyamine, for example a linear aliphatic polyamine such as, for example, hexamethylenediamine, an aliphatic polyamine such as, for example, hexamethylenediamine or aniline, an aliphatic polyamine such as, for example, a linear aliphatic polyamine such as for example hexamethylenediamine and triethylenetetramine, or a cyclic aliphatic polyamine such as isophorone diamine.

In one embodiment, the polymer solvolysis mixture comprises:
i. at least one polyol and/or polyamine, preferably with a molar mass in the range of 50-10,000 g/mol, more preferably 60-6,000 g/mol; and
ii. at least one cleavage reagent selected from alcohol, polycarboxylic acid, polycarboxylic anhydride, polyamine and/or water, with a molar mass of ≤250 g/mol, preferably in the range from 15 to 180 g/mol.

The polyol in component i. is preferably an aliphatic polyol, an aromatic polyol, a polyester polyol and/or a polyether polyol, more preferably an aliphatic diol, an aromatic diol, a polyester diol and/or a polyether diol.

The polyol in component i. can have a molar mass in the range of 50-10,000 g/mol, preferably 60-6,000 g/mol.

The polyamine in component i. is preferably an aliphatic polyamine, an aromatic polyamine, a polyesterpolyamine and/or a polyetherpolyamine, more preferably an aliphatic diamine, an aromatic diamine, a polyester diamine and/or a polyether diamine.

The polyamine in component i. can have a molar mass in the range of 20-1000 g/mol, preferably 60-600 g/mol.

The at least one alcohol in component ii. is preferably at least one monoalcohol, in particular methanol, ethanol, propanol, butanol, pentanol and/or hexanol, hydroxycarboxylic acid, hydroxylamine, at least one diol, in particular ethylene glycol, diethylene glycol, polyethylene glycol, propylene glycol, dipropylene glycol, polypropylene glycol, butanediol, pentanediol and/or hexanediol, at least one triol, in particular glycerol and/or trimethylolpropane, and/or a polyol, more preferably at least one monoalcohol and/or at least one diol, more preferably at least one diol.

The at least one polycarboxylic acid in component ii. is preferably at least one dicarboxylic acid, in particular succinic acid, glutaric acid, adipic acid, hexanedicarboxylic acid, azealic acid and/or phthalic acid, and/or at least one tricarboxylic acid, in particular trimelitic acid.

The at least one polycarboxylic acid anhydride in component ii. is preferably at least one dicarboxylic acid anhydride, in particular succinic acid anhydride, glutaric acid anhydride, adipic acid anhydride, hexanedicarboxylic acid anhydride, azealic acid anhydride and/or phthalic acid anhydride, and/or at least one tricarboxylic acid anhydride, in particular trimelic acid anhydride.

The at least one polyamine in component ii. is preferably at least one diamine, in particular ethanediamine, propanediamine, butanediamine, pentanediamine and/or hexanediamine, and/or at least one triamine, in particular ethanetriamine, propanetriamine, butanetriamine and/or hexanetriamine, more preferably at least one diamine.

Component i. and component ii. are preferably different.

In a further embodiment, the polymer solvolysis mixture further comprises:
iii. at least one catalyst, in particular suitable for degrading polymers, preferably at least one alkaline catalyst and/or an organometallic catalyst; and
iv. optionally at least one additive, in particular selected from the group consisting of filler, pigment, flame retardant, plasticizer and stabilizer.

The at least one alkaline catalyst in component iii. can be an alkali metal alcoholate, in particular sodium methanolate, potassium methanolate, sodium ethanolate, potassium ethanolate, sodium propanolate, potassium propanolate, sodium butanolate and/or potassium butanolate, alkali metal hydroxide, in particular sodium hydroxide and/or potassium hydroxide, and/or alkali metal acetate, in particular sodium acetate and/or potassium acetate.

The at least one organometallic catalyst in component iii. may be selected from the group consisting of zinc acetate, magnesium acetate, cobalt acetate, zinc acetate, magnesium acetate, cobalt acetate, tin octoate, dibutyltin dilaurate, titanium tetraisopropanolate and titanium tetrabutanolate.

Component i. preferably makes up 5-80% by weight of the total mass of the polymer solvolysis mixture.

Component ii. preferably makes up 20-95% by weight of the total mass of the polymer solvolysis mixture.

Component iii. preferably makes up 0-30 wt. %, more preferably 1-20 wt. % based on the total mass of the polymer solvolysis mixture.

Component iv. preferably makes up 0-40 wt. %, more preferably 1-30 wt. % based on the total mass of the polymer solvolysis mixture.

The pressure in step (b) can be <1 mbar, preferably ≤0.5 mbar, preferably ≤0.1 mbar, more preferably from 0.0001 to 0.1 mbar.

The temperature in step (b) can be in the range of 60-170° C., preferably 80-150° C., more preferably 90-130° C.

In a further embodiment, the polymer solvolysis mixture is treated in step (b) for 2-10,000 seconds, preferably 5-5,000 seconds, more preferably 10-500 seconds.

In a further embodiment, the process is carried out in a thin film evaporator or a short path evaporator, more preferably in a short path evaporator.

The above-mentioned evaporators basically comprise a heated surface as a heating device for transferring the substance to be separated from a mixture from the liquid phase into the gas phase (forming the vapors) and a condensation device on which the separated gas phase (the vapors) can be condensed again.

In a thin film evaporator, the mixture to be separated is usually distributed from above on the heating jacket via a rotating distributor system, which sits on a cylindrical heating jacket of the thin film evaporator. The mixture flows down the inner wall of the heating jacket due to gravity and forms a liquid film. A mechanical wiping system inside the heating jacket can ensure even distribution and permanent mixing of the mixture on the inner wall of the heating jacket. The lower boiling component of the mixture evaporates out of the liquid film and forms the vapors. The vapors are discharged from the evaporator and fed to a downstream external condenser for condensation. This process is characterized in particular by a short residence time, low working pressures and therefore low evaporation temperatures.

In contrast to the thin film evaporator, the condenser in a short path evaporator is usually located inside the heating jacket of the evaporator. The vapors emerging from the liquid film now only have to travel a short distance within the evaporator before they condense on the surface of the internal condenser. As the pressure difference required for vapour transport over this short distance is extremely low, very low working pressures can be realized. The necessary evaporation temperatures are therefore very low.

The process according to the invention can be a continuous process.

The at least one compound in step (c) is preferably a cleavage reagent and more preferably has a molar mass of 25-250 g/mol, more preferably 30-200 g/mol.

The at least one compound in step (c) preferably comprises a cleavage reagent and is more preferably selected from the group consisting of alcohol, polycarboxylic acid, polycarboxylic acid anhydride, carboxylic acid ester, polyamine, water and formaldehyde.

The alcohol in step (c) can be a monoalcohol, in particular methanol, ethanol, propanol, butanol, pentanol and/or hexanol, a diol, in particular ethylene glycol, diethylene glycol, polyethylene glycol, propylene glycol, dipropylene glycol, polypropylene glycol, butanediol, pentanediol and/or hexanediol, a triol, in particular glycerol and/or trimethylolpropane and/or a polyol, preferably a monoalcohol and/or a diol, more preferably a diol.

The polycarboxylic acid in step (c) may be a dicarboxylic acid, in particular succinic acid, glutaric acid, adipic acid, hexanedicarboxylic acid, azealic acid and/or phthalic acid, and/or a tricarboxylic acid, in particular trimelitic acid.

The polycarboxylic acid anhydride in step (c) may be a dicarboxylic acid anhydride, in particular succinic acid anhydride, glutaric acid anhydride, adipic acid anhydride, hexanedicarboxylic acid anhydride, azealic acid anhydride and/or phthalic acid anhydride, and/or a tricarboxylic acid anhydride, in particular trimelitic acid anhydride.

The polyamine in step (c) can be a diamine, in particular ethanediamine, propanediamine, butanediamine, hexanediamine, toluene diamine and/or diaminodiphenylmethane, and/or a triamine, in particular ethanetriamine, propanetriamine, butanetriamine and/or hexanetriamine, preferably a diamine.

The mixture of substances obtained after step (c) is substantially free of the at least one compound in step (c). “Substantially free of the at least one compound in step (c)” preferably means that the mixture of substances obtained after step (c) contains 0.05-50% by weight, more preferably 0.1-20% by weight, more preferably 0.5-8% by weight, of the at least one compound in step (c), based on the total weight of the mixture of substances obtained after step (c).

In a preferred embodiment, the proportion of the compound in the mixture of substances after step (c) is reduced by 80%, in particular 80% by weight, compared to the proportion of the compound in the polymer solvolysis mixture after step (a). The content of the compound can be determined using methods known in the art for quantifying substances in a mixture, such as GC-MS.

The mixture of substances obtained after step (c) preferably has a KOH number (OHZ) in the range from 20-600 mg KOH, more preferably in the range from 50 to 95 mg KOH, more preferably 60-90 mg KOH. The KOH number is a measure of the content of hydroxyl groups in organic substances. Methods for determining the KOH number are known in the field and are described, for example, in DIN 53240.

The at least one compound removed in step (c) can be reused as a cleavage reagent in solvolysis. Due to the high costs of cleavage reagents for solvolysis, particularly in the case of polyamines, the separation of unreacted cleavage reagent from a polymer solvolysis mixture is particularly advantageous from an economic point of view.

Before or after the process according to the invention, catalyst can be recovered by suitable means known to the person skilled in the art, such as filtration, and, optionally, fed to a solvolysis.

The purification process according to the invention is superior to the purification processes known from the prior art.

Usually, substances, e.g. cleavage reagent or by-products, are present in the polymer solvolysis mixture after solvolysis, which complicate or even prevent the immediate further processing of the polymer solvolysis mixture for the production of new polymers. The process according to the invention is able to remove these substances from the polymer solvolysis mixture almost quantitatively. Surprisingly, at the same time it is ensured that the side reactions that take place during conventional purification to form polymerizate or higher molecular weight by-products can be largely avoided. As a result, the purified polymer solvolysis mixture remains low-viscous, homogeneous and storage-stable without the need to add stabilizers such as emulsifiers.

In contrast to conventional recyclates, the material mixtures obtainable according to the process of the invention can be used in larger concentrations or even as the sole building block for the production of polymers, such as polyurethane, polyester, polycarbonate and/or polyamide, more preferably polyurethane and/or polyester, even more preferably polyurethane.

A further advantage of the process according to the invention is that the cleavage reagents can be used in excess without any problems in the solvolysis preceding the purification, since effective purification is then ensured. The solvolysis itself can then be carried out quantitatively at low temperatures and low amounts of catalyst or even without a catalyst.

A further aspect of the invention therefore relates to the use of the mixture of substances obtained after step (c) for the production of a polymer, in particular a polyurethane, polyester, polycarbonate and/or polyamide, more preferably a polyurethane and/or polyester, even more preferably a polyurethane.

A further aspect of the invention relates to the mixture of substances obtainable by the method described above.

The polymer products manufactured in this way are particularly low in volatile substances. This rules out the emission of harmful substances from the polymer products and ensures consumer safety.

Furthermore, the present invention will be explained by the following examples.

### EXAMPLE 1 (COMPARATIVE EXAMPLE)

500 g dipropylene glycol (cleavage reagent) is provided in excess and heated to 200° C. 500 g of flexible polyurethane foam residues (standard foam based on TDI and ether polyols for the production of mattresses) are added to the 200° C. hot mixture under stirring and N2 atmosphere within 1 hour.

After a further reaction time of 2 h, a homogeneous, brown, clear polyol mixture (polymer solvolysis mixture) with a KOH number of 434 mg KOH/g and a viscosity of 340 mPas/25° C. is generated.

Due to the high proportion of cleaving reagent and the associated high KOH number, this mixture of substances cannot substitute the standard polyols used in the production of flexible foams (KOH number 28-56 mg KOH/g).

The addition of just 1-5% of this mixture of substances in flexible foam formulations (substitution of the ether polyol) drastically changes properties of the flexible foam (e.g. compression hardness), so that it is not possible to reuse the mixture of substances to the production of flexible foam.

### EXAMPLE 2 (COMPARATIVE EXAMPLE)

In order to reduce the hydroxyl number of the polymer solvolysis mixture, the cleavage reagent dipropylene glycol is reduced. In order to achieve sufficient reaction times, the temperature is increased and a catalyst is added.

200 g dipropylene glycol (cleavage reagent) is mixed with 0.1% catalyst (titanium butylate) and heated to 210° C.

400 g of polyurethane flexible foam residues (standard flexible foam based on TDI and ether polyol) are dosed into the 210° C. hot mixture under N2 (inertization) within 4 hours.

After a further reaction time of 4 h, a highly viscous, agglomerated polymer solvolysis mixture with a KOH number of 278 mg KOH/g is produced.

Due to the equilibrium reaction, even a slight reduction of the cleavage reagent leads to longer reaction times and to a coarsely agglomerated, particle-containing and highly viscous polymer solvolysis mixture that cannot be used for foam production.

### EXAMPLE 3 (COMPARATIVE EXAMPLE) 500 g of diproplene glycol and 500 g of flexible polyurethane foam are reacted according to example 1.

After an additional reaction of 2h, a vacuum is applied at 200° C. and the cleavage reagent is distilled off under vacuum.

After a distillation time of 10 h with a final vacuum of 50 mbar absolute, 240 g of dipropylene glycol could be distilled off. Due to the long distillation time at higher temperatures, the concentration of undesirable, toxic by-products such as TDA (toluylene diamine) increased as a result of the thermal stress. The shift in equilibrium during the distillation of the cleavage reagent led to a build-up of molar mass and thus to an increase in viscosity and separation (phase separation).

Due to the reduction/distillation of the cleavage reagent, the solubility/miscibility of the mixture changes and at higher temperatures the components of the mixture tend to agglomerate/separate phase.

From the original, clear and homogeneous dispersion, a highly agglomerated, highly viscous dispersion with agglomerates of more than 100 μm was produced, which cannot be used as a polyol component for foam production.

### EXAMPLE 4: (COMPARATIVE EXAMPLE) 500 g of dipropylene glycol and 500 g of flexible polyurethane foam are reacted according to example 1.

To reduce the hydroxyl number, the cleavage reagent is distilled off under vacuum. To avoid molar mass build-up and agglomeration/phase separation (example 3), distillation is carried out at low temperatures: The polymer solvolysis mixture was cooled and at 120° C. and 13 mbar the cleavage reagent was distilled off.

After 1 h of distillation, the distillation came to a standstill. Only 3% cleavage reagent could be distilled off, the KOH number of the mixture was reduced to only 425 mg KOH/g. The sump temperature was increased to 130° C. and distillation continued at 13 mbar. The sump temperature was further increased. After 4 h of distillation at 130° C. sump temperature and 13 mbar vacuum, the distillation came to a standstill after 3.5 h. Only 22.6% of the cleavage reagent could be distilled off. The KOH number was reduced to only 369 mg KOH/g. The mixture is homogeneous and clear.

The sump temperature was increased again by 10° C. to 140° C. in order to be able to distill off further cleavage reagent. After a further 1.5 h distillation time at 140° C., another 35.7% of cleavage reagent could be distilled off before the distillation came to a standstill. The KOH number was reduced to only 282 mg KOH/g. The mixture is no longer clear, but contains coarse agglomerates >100 μm.

The cleavage reagent could not be separated quantitatively. Only 61.2% of the cleavage reagent could be distilled off, reducing the KOH number to only 282 mg KOH/g. This means that this mixture of substances cannot be used as a raw material for the production of flexible foam, at least not to any significant extent.

In order to be able to distill at all, higher sump temperatures were necessary, which in turn lead to the disadvantageous formation of higher molar masses, agglomerates/phase separations and by-products.

### EXAMPLE 5

5000 g of diproyplene glycol and 5000 g of flexible polyurethane foam are reacted according to example 1. After additional reaction of 2 hours, the resulting polymer solvolysis mixture with a KOH number of 436 mg KOH/g is cooled and continuously fed into a short path evaporator.

At a temperature of 90° C. of the evaporator jacket and a pressure of 0.04 mbar, 42.6 wt. % (85.2% of the cleavage reagent) was continuously distilled off. The remaining mixture of substances (57.4%) is liquid, finely dispersed (disperse fractions <10 μm) and completely storage-stable. The KOH number of the product is 132 mg KOH/g.

The mixture of substances material can be used directly as a polyol component for the production of polyurethane polymers. Due to the low distillation temperatures, the mixtures produced are liquid, homogeneous and stable in phase and storage. At the low temperatures, the reverse reaction (molar mass build-up) is kinetically inhibited to a significant degree. The mixtures are also phase-stable at these low temperatures, i.e. agglomeration/separation does not occur.

Due to the low KOH number, higher amounts of the mixture of substances in the range of at least 20-50% can easily added for PUR flexible foam production.

Due to the ideal process conditions in the thin film/short path evaporator, the cleavage reagent can be distilled off quantitatively (>85%) and economically even at favorably low temperatures.

The separated cleavage reagent (here dipropylene glycol) has a purity >97% and can be used again as a redistillate as a cleavage reagent.

### EXAMPLE 6

5000 g of dipropylene glycol and 5000 g of PUR flexible foam are reacted as in example 5, cooled and added to a short path evaporator as a feed at 80° C.

In contrast to example 5, the temperature of the evaporator is increased to 170° C. and then cooled down to 80° C. According to examples 3 and 4 (already at 140° C.), higher distillation temperatures lead to disadvantageous agglomeration and molar mass build-up with longer distillation times.

At an evaporator jacket temperature of 170° C. and a pressure of 0.04 mbar, 48.4% by weight was continuously distilled off (96.8% of the cleavage reagent). The remaining mixture (51.6%) is liquid, finely dispersed and completely storage-stable in. The KOH number of the mixture is 92 mg KOH/g. The viscosity is 3605 mPas/25° C.

Due to the extremely low residence time in the evaporator of only 2 min, the negative effects such as molar mass build-up and/or agglomeration/separation could be avoided even at higher distillation temperatures.

### EXAMPLE 7

A polymer solvolysis mixture made from 500 g diethylene glycol and 500 g PUR integral foam contains 0.12% 1,4-dioxane, which is a by-product of the acid-catalyzed reaction of diethylene glycol.

1,4-dioxane is classified as carcinogenic and is therefore detrimental in the polymer solvolysis products. After distillation in the short path/thin film evaporator according to example 5, the 1,4-dioxane content is reduced to <0.01%. In other words, in addition to the distillation of the cleavage reagent, by-products or fractions are also advantageously separated, resulting in purer and low-emission mixtures of substances.

### EXAMPLE 8

500 g of polyurethane foam (containing foam stabilizer) is reacted with catalyst and 500 g of diethylene glycol according to example 1 (glycolysis). The solvolysis mixture thus produced is subjected to decreasing pressure at low temperatures in a conventional distillation apparatus in order to distill off free diethylene glycol. At a pressure of 160 mbar (absolute) and a sump temperature of 141° C., slight foaming is observed. With decreasing pressure (110 mbar) and increasing sump temperature (150° C.), foaming increases significantly. At pressures below 106 mbar and 150° C. sump temperature, the foam formation was so strong that distillation of diethylene glycol from the solvolysis crude mixture was no longer possible. Increasing the stirrer speed did not help.

The addition of defoamers is not possible, as these prevent subsequent polyurethane foam production with the solvolysis mixture according to the invention.

The solvolysis mixture can only be distilled extremely slowly (>48h) at pressures >100 mbar. The long distillation times lead to undesirable polymer degradation.

### EXAMPLE 9

The purification of a solvolysis mixture according to example 8 was carried out using a thin-film evaporator.

Even at temperatures of 150° C. and at pressures <1 mbar, there is no significant foam formation in the thin film evaporator. Compared to example 8, the purification time in the thin film evaporator can be reduced by a factor of 8-12 for the same volume of raw solvolysis mixture and identical diethylene glycol content in the purified product.

The solvolysis mixture produced in this way can be used for foam production.

The following points are the subject of the invention:
1. A process for purifying a polymer solvolysis mixture comprising the steps of:
   (a) providing the polymer solvolysis mixture;
   (b) treating the polymer solvolysis mixture at a pressure <1 mbar and a temperature in the range from 90 to 170° C.; and
   (c) removing at least one compound having a molar mass of ≤250 g/mol during step (b) to obtain a mixture of substances.
2. Process according to point 1, wherein the polymer solvolysis mixture is obtainable by solvolysis of at least one polymer selected from the group consisting of polyurethane, polyester, polyether ester, polyamide, polycarbonate, polyisocyanurate, preferably polyurethane and polyester, more preferably polyurethane, in particular polyesterpolyurethane and/or polyetherpolyurethane.
3. Process according to point 2, wherein the solvolysis is a glycolysis, alcoholysis, acidolysis, aminolysis or hydrolysis, preferably an alcoholysis or an aminolysis, more preferably an alcoholysis.
4. Process according to point 3, wherein the alcoholysis is carried out using at least one monoalcohol, in particular methanol, ethanol, propanol, butanol, pentanol and/or hexanol, at least one diol, in particular ethylene glycol, diethylene glycol, polyethylene glycol, propylene glycol, dipropylene glycol, polypropylene glycol, butanediol, pentanediol and/or hexanediol, at least one triol, in particular glycerol and/or trimethylolpropane, and/or at least one tetrol, in particular pentaerythrol and/or at least one hydroxycarboxylic acid, in particular ricinoleic acid and lactic acid, preferably using at least one monoalcohol and/or at least one diol, more preferably using at least one diol, as cleavage reagent.
5. Process according to point 3, wherein the acidolysis is carried out using at least one polycarboxylic acid, in particular a dicarboxylic acid, such as succinic acid, glutaric acid, adipic acid, hexanedicarboxylic acid, heptanedicarboxylic acid, azealic acid, sebacic acid, decanedicarboxylic acid, dodecanedicarboxylic acid and/or phthalic acid, and/or at least one tricarboxylic acid, such as trimelitic acid, and/or using at least one polycarboxylic acid anhydride, in particular a dicarboxylic acid anhydride, such as succinic acid anhydride, glutaric acid anhydride, adipic acid anhydride, hexanedicarboxylic acid anhydride, azealic acid anhydride and/or phthalic acid anhydride, and/or at least one tricarboxylic acid anhydride, such as trimelittic acid anhydride, particularly preferably using at least one polycarboxylic acid, more preferably using at least one dicarboxylic acid, as a cleavage reagent.
6. Process according to point 3, wherein the aminolysis is carried out using at least one polyamine, in particular at least one diamine, such as ethanediamine, propanediamine, butanediamine and/or hexanediamine, and/or at least one triamine, such as ethanetriamine, propanetriamine, butanetriamine, pentanetriamine, hexanetriamine and/or at least one hydroxylamine, such as ethanolamine, preferably using at least one diamine, as cleavage reagent.
7. Process according to point 3, wherein the hydrolysis is carried out using water as the cleavage reagent.
8. Process according to any one of points 2 to 7, wherein the solvolysis is further carried out using at least one catalyst suitable for degrading polymers, in particular an alkaline and/or organometallic catalyst.
9. Process according to point 8, wherein the at least one alkaline catalyst is selected from the group consisting of alkali metal alcoholate, in particular sodium methanolate, potassium methanolate, sodium ethanolate, potassium ethanolate, sodium propanolate, potassium propanolate, sodium butanolate and/or potassium butanolate, alkali metal hydroxide, in particular sodium hydroxide and/or potassium hydroxide, and alkali metal acetate, in particular sodium acetate and potassium acetate.
10. Process according to point 8, wherein the at least one organometallic catalyst is selected from the group consisting of zinc acetate, magnesium acetate, cobalt acetate, tin octoate, dibutyltin dilaurate, titanium tetraisopropanolate and titanium tetrabutanolate.
11. Process according to any one of points 2-10, wherein the solvolysis is carried out
   at elevated temperature, in particular at a temperature in the range 30-300° C., preferably 100-250° C., more preferably 140-220° C.; and
   optionally at increased pressure, in particular at a pressure of 1-200 bar, preferably 5-50 bar, more preferably 10-30 bar.
12. Process according to any one of the preceding points, wherein the polymer solvolysis mixture comprises at least one polymer degradation product, at least one cleavage reagent and optionally at least one catalyst.
13. Process according to any one of the preceding points, wherein the polymer solvolysis mixture comprises:
   i. at least one polyol and/or polyamine, preferably having a molar mass in the range of 50-10,000 g/mol, more preferably 60-6,000 g/mol; and
   ii. at least one cleavage reagent selected from alcohol, polycarboxylic acid, polycarboxylic anhydride, polyamine and/or water, having a molar mass of ≤250 g/mol, preferably in the range from 15 to 180 g/mol.
14. Process according to point 13, wherein the polyol in component i. is an aliphatic polyol, an aromatic polyol, a polyester polyol and/or a polyether polyol, preferably an aliphatic diol, an aromatic diol, a polyester diol and/or a polyether diol.
15. Process according to any one of points 13-14, wherein the polyol in component i. has a molar mass in the range of 50-10,000 g/mol, more preferably 60-6,000 g/mol.
16. Process according to any one of points 13-15, wherein the polyamine in component i. is an aliphatic polyamine, an aromatic polyamine, a polyesterpolyamine and/or a polyetherpolyamine, preferably an aliphatic diamine, an aromatic diamine, a polyester diamine and/or a polyether diamine.
17. Process according to any one of points 13-16, wherein the polyamine in component i. has a molar mass in the range of 20-1000 g/mol, more preferably 60-600 g/mol.
18. Process according to any one of points 13-17, wherein the at least one alcohol in component ii. is at least one monoalcohol, in particular methanol, ethanol, propanol, butanol, pentanol and/or hexanol, at least one hydroxycarboxylic acid, at least one hydroxylamine, at least one diol, in particular ethylene glycol, diethylene glycol, polyethylene glycol, propylene glycol, dipropylene glycol, polypropylene glycol, butanediol, pentanediol and/or hexanediol, at least one triol, in particular glycerol and/or trimethylolpropane, and/or at least one polyol, preferably at least one monoalcohol and/or one diol, more preferably at least one diol.
19. Process according to any one of points 13-18, wherein the at least one polycarboxylic acid in component ii. is at least one dicarboxylic acid, in particular succinic acid, glutaric acid, adipic acid, hexanedicarboxylic acid, azealic acid and/or phthalic acid, and/or at least one tricarboxylic acid, in particular trimelic acid.
20. Process according to one of points 13-19, wherein the at least one polycarboxylic acid anhydride in component ii. is at least one dicarboxylic acid anhydride, in particular succinic acid anhydride, glutaric acid anhydride, adipic acid anhydride, hexanedicarboxylic acid anhydride, azealic acid anhydride and/or phthalic acid anhydride, and/or at least one tricarboxylic acid anhydride, in particular trimelitic acid anhydride.
21. Process according to any one of points 13-20, wherein the at least one polyamine in component ii. is at least one diamine, in particular ethanediamine, propanediamine, butanediamine, pentanediamine and/or hexanediamine, and/or at least one triamine, in particular ethanetriamine, propanetriamine, butanetriamine and/or hexanetriamine, preferably at least one diamine.
22. Process according to any one of points 13-21, wherein component i. and component ii. are different.
23. Process according to any one of points 13-22, wherein the polymer solvolysis mixture further comprises:
   iii. at least one catalyst, in particular suitable for degrading polymers, preferably at least one alkaline catalyst and/or an organometallic catalyst; and
   iv. optionally at least one additive, in particular selected from the group consisting of filler, pigment, flame retardant, platicizer and stabilizer.
24. Process according to point 23, wherein the at least one alkaline catalyst is at least one alkali metal alcoholate, in particular sodium methanolate, potassium methanolate, sodium ethanolate, potassium ethanolate, sodium propanolate, potassium propanolate, sodium butanolate and/or potassium butanolate, at least one alkali metal hydroxide, in particular sodium hydroxide and/or potassium hydroxide, and/or at least one alkali metal acetate, in particular sodium acetate and/or potassium acetate.
25. Process according to point 23, wherein the at least one organometallic catalyst is selected from the group consisting of zinc acetate, magnesium acetate, cobalt acetate, tin octoate, dibutyltin dilaurate, titanium tetraisopropanolate and titanium tetrabutanolate.
26. Process according to any one of points 13 to 25, wherein component i. makes up 5-80% by weight based on the total mass of the polymer solvolysis mixture.
27. Process according to any one of points 13 to 26, wherein component ii. makes up 20-95% by weight based on the total mass of the polymer solvolysis mixture.
28. Process according to any one of points 23 to 27, wherein component iii. makes up 0-30% by weight based on the total mass of the polymer solvolysis mixture.
29. Process according to any one of points 23 to 28, wherein component iv. makes up 0-40% by weight based on the total mass of the polymer solvolysis mixture.
30. Process according to any one of the preceding points, wherein the pressure in step (b) is <1 mbar, preferably ≤0.5 mbar, preferably ≤0.1 mbar, more preferably from 0.0001 to 0.1 mbar.
31. Process according to any one of the preceding points, wherein the temperature in step (b) is in the range of 60-170° C., preferably 80-150° C., more preferably 90-130° C.
32. Process according to any one of the preceding points, wherein the polymer solvolysis mixture is treated in step (b) for 2-10,000 seconds, preferably 5-5,000 seconds, particularly preferably 10-500 seconds.
33. Process according to any one of the preceding points, wherein the process is carried out in a thin film evaporator or a short path evaporator, preferably in a short path evaporator.
34. Process according to any one of the preceding points, wherein the method is a continuous method.
35. Process according to any one of the preceding points, wherein the at least one compound in step (c) has a molar mass of 25-250 g/mol, preferably of 30-200 g/mol.
36. Process according to any one of the preceding points, wherein the at least one compound in step (c) comprises cleavage reagent and is preferably selected from the group consisting of alcohol, polycarboxylic acid, polycarboxylic anhydride, carboxylic acid ester, polyamine, water and formaldehyde.
37. Process according to point 36, wherein the alcohol in step (c) is a monoalcohol, in particular methanol, ethanol, propanol, butanol, pentanol and/or hexanol, a diol, in particular ethylene glycol, diethylene glycol, polyethylene glycol, propylene glycol, dipropylene glycol, polypropylene glycol, butanediol, pentanediol and/or hexanediol, a triol, in particular glycerol and/or trimethylolpropane and/or a polyol, in particular dipropylene glycol, polypropylene glycol, butanediol, pentanediol and/or hexanediol, a triol, in particular glycerol and/or trimethylolpropane and/or a polyol, preferably a monoalcohol and/or a diol, more preferably a diol.
38. Process according to point 36, wherein the polycarboxylic acid in step (c) is a dicarboxylic acid, in particular succinic acid, glutaric acid, adipic acid, hexanedicarboxylic acid, azealic acid and/or phthalic acid, and/or a tricarboxylic acid, in particular trimelitic acid.
39. Process according to point 36, wherein the polycarboxylic acid anhydride in step (c) is a dicarboxylic acid anhydride, in particular succinic acid anhydride, glutaric acid anhydride, adipic acid anhydride, hexanedicarboxylic acid anhydride, azealic acid anhydride and/or phthalic acid anhydride, and/or a tricarboxylic acid anhydride, in particular trimelitic acid anhydride.
40. Process according to point 36, wherein the polyamine in step (c) is a diamine, in particular ethanediamine, propanediamine, butanediamine, hexanediamine, toluene diamine and/or diaminodiphenylmethane, and/or a triamine, in particular ethanetriamine, propanetriamine, butanetriamine and/or hexanetriamine, preferably a diamine.
41. Process according to any one of the preceding points, wherein the mixture of substances obtained after step (c) contains 0.05-50% by weight, preferably 0.1-20% by weight, more preferably 0.5-8% by weight, of the at least one compound in step (c), based on the total weight of the mixture of substances obtained after step (c).
42. Process according to anyone of the preceding points, wherein the proportion of the compound in the mixture of substances after step (c) is reduced by 80% compared to the proportion of the compound in the polymer solvolysis mixture after step (a).
43. Process according to any one of the preceding points, wherein the mixture of substances obtained after step (c) has a KOH number in the range from 20-600 mg KOH, preferably in the range from 50 to 95 mg KOH, more preferably 60-90 mg KOH.
44. Use of the mixture of substances obtained according to point 1 (c) for the preparation of a polymer, in particular a polyurethane, polyester, polycarbonate and/or polyamide, more preferably a polyurethane and/or polyester, even more preferably a polyurethane.
45. A mixture of substances obtainable by a process according to any one of points 1-43.

1. A process for purifying a polymer solvolysis mixture comprising the steps of:
a. providing the polymer solvolysis mixture obtainable by solvolysis of at least one polymer selected from the group consisting of polyurethane, polyester, polyether ester, polyamide, polycarbonate, polyisocyanurate,
b. treating the polymer solvolysis mixture at a pressure <1 mbar and a temperature in the range from 90 to 170° C.; and
c. removing at least one compound with a molar mass of ≤250 g/mol during step (b) to obtain a mixture of substances.

2. The process according to claim 1, wherein the solvolysis is a glycolysis, alcoholysis, acidolysis, aminolysis or hydrolysis, preferably an alcoholysis or an aminolysis, more preferably an alcoholysis, and is preferably carried out
at elevated temperature, in particular at a temperature in the range 30-300° C., preferably 100-250° C., more preferably 140-220° C.; and
optionally at increased pressure, in particular at a pressure of 1-200 bar, preferably 5-50 bar, more preferably 10-30 bar.

3. The process according to claim 1, wherein the polymer solvolysis mixture further comprises:
v. at least one catalyst, in particular suitable for degrading polymers, preferably at least one alkaline catalyst and/or an organometallic catalyst; and
vi. optionally at least one additive, in particular selected from the group consisting of filler, pigment, flame retardant, plasticizer and stabilizer.

4. The process according to claim 1, wherein the pressure in step (b) is <1 mbar, preferably ≤0.5 mbar, preferably ≤0.1 mbar, more preferably from 0.0001 to 0.1 mbar, and
wherein the temperature in step (b) is preferably in the range of 60-170° C., preferably 80-150° C., more preferably 90-130° C., and
wherein the polymer solvolysis mixture is treated in step (b) for 2-10,000 seconds, preferably 5-5,000 seconds, more preferably 10-500 seconds.

5. The process according to claim 1, wherein the process is carried out in a thin film evaporator or a short path evaporator, preferably in a short path evaporator.

6. The process according to claim 1, wherein the method is a continuous method.

7. The process according to claim 1, wherein the at least one compound in step (c) has a molar mass of 25-250 g/mol, preferably 30-200 g/mol.

8. The process according to claim 1, wherein the at least one compound in step (c) comprises cleavage reagent and is preferably selected from the group consisting of alcohol, polycarboxylic acid, polycarboxylic acid anhydride, carboxylic acid ester, polyamine, water and formaldehyde.

9. The process according to claim 1, wherein the mixture of substances obtained after step (c) contains 0.05-50% by weight, preferably 0.1-20% by weight, more preferably 0.5-8% by weight, of the at least one compound in step (c), based on the total weight of the mixture of substances obtained after step (c).

10. The process according to claim 1, wherein the proportion of the compound in the mixture of substances after step (c) is reduced by 80% compared to the proportion of the compound in the polymer solvolysis mixture after step (a).

11. The process according to claim 1, wherein the mixture of substances obtained after step (c) has a KOH number in the range from 20-600 mg KOH, preferably in the range from 50 to 95 mg KOH, more preferably 60-90 mg KOH.

12. The method for purifying a polymer solvolysis mixture according to claim 1, wherein said polymer solvolysis mixture comprises a polyurethane, polyester, polycarbonate and/or polyamide.

13. A mixture of substances obtainable by a process according to claim 1.

14. The method according to claim 12, wherein said polymer solvolysis mixture comprises a polyurethane and/or polyester.

15. The method according to claim 14, wherein said polymer solvolysis mixture comprises, polyurethane.
